(19) United States
(12) Patent Application Publication
(10) Pub. No.: US 2016/0275973 A1
(43) Pub. Date: Sep. 22, 2016

(54) DEVICES INCLUDING AN OVERCOAT THAT INCLUDES A LOW THERMAL CONDUCTIVITY LAYER

(71) Applicant: SEAGATE TECHNOLOGY LLC, Cupertino, CA (US)

(72) Inventors: Yuhang Cheng, Edina, MN (US); Michael Seigler, Eden Prairie, MN (US); Scott Franzen, Savage, MN (US)

(21) Appl. No.: 15/073,411

(22) Filed: Mar. 17, 2016

Related U.S. Application Data
(60) Provisional application No. 62/136,588, filed on Mar. 22, 2015.

(51) Int. Cl. G11B 5/40; G11B 5/147

(52) U.S. Cl. CPC G11B 5/40; G11B 5/147; G11B 2005/0021

(57) ABSTRACT

Devices having an air bearing surface (ABS), the device including a write pole; a near field transducer (NFT) that includes a peg and a disc, wherein the peg is at the ABS of the device; an overcoat that includes a low thermal conductivity layer, the low thermal conductivity layer including a material that has a thermal conductivity of not greater than 5 W/mK.

### PRIORITY

This application claims priority to U.S. Provisional Application No. 62/136,588 entitled HEAD OVERCOAT WITH LOW THERMAL CONDUCTIVITY, filed on Mar. 22, 2015 the disclosure of which is incorporated herein by reference thereto.

### SUMMARY

Disclosed are devices having an air bearing surface (ABS), the device including a write pole; a near field transducer (NFT) that includes a peg and a disc, wherein the peg is at the ABS of the device; an overcoat that includes a low thermal conductivity layer, the low thermal conductivity layer including a material that has a thermal conductivity of not greater than 5 W/mK.

Also disclosed are devices having an air bearing surface (ABS), the device including a write pole; a near field transducer (NFT) that includes a peg and a disc, wherein the peg is at the ABS of the device; an overcoat that includes a low thermal conductivity layer in contact with at least the peg of the NFT, the low thermal conductivity layer including a material that has a thermal conductivity of not greater than 5 W/mK.

Also disclosed are devices that have an air bearing surface (ABS), the device including a write pole; a near field transducer (NFT) that includes a peg and a disc, wherein the peg is at the ABS of the device; an overcoat that includes a low thermal conductivity layer in contact with at least the peg of the NFT, the low thermal conductivity layer including a material that has a thermal conductivity of not greater than 5 W/mK; and a protective layer.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a perspective view of a magnetic disc drive that can include HAMR devices.

FIG. 2 is a cross sectional view of a HAMR magnetic recording head and of an associated recording medium.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Heat assisted magnetic recording (referred to through as HAMR) utilizes radiation, for example from a laser, to heat media to a temperature above its curie temperature, enabling magnetic recording. In order to deliver the radiation, e.g., a laser beam, to a small area (on the order of 20 to 50 nm for example) of the medium, a NFT is utilized. During a magnetic recording operation, the NFT absorbs energy from a laser and focuses it to a very small area; this can cause the temperature of the NFT, particularly the peg of the NFT to increase.

In addition, the magnetic media can cause heat to be directed back towards the recording device, this can be referred to as media back heating. Media back heating can further increase the peg temperature. The media surface is not perfectly smooth it can include significant nanometer to micrometer range asperities over its surface. When the peg flies over the asperities, laser heating can heat up the temperature of the asperities to a temperature that is much higher than the average temperature of the media in the heating zone. Those asperities may transport heat to the peg tip through either direct contact or radiation. This heat could also be transmitted to the peg via materials that have built up on the peg, which may have relatively high thermal conductivities. Furthermore, during writing, laser heating together with writer coil heating will generate a localized protrusion surrounding the peg as well as localized protrusion on the media surface. This may further increase the possibility of direct contact of asperities on the media with the peg tip.

The combination of light absorption, and media back heating can cause the peg temperature to increase to a very high level (e.g., even greater than 400° C.). The high temperature over the peg surface and the NFT can drive diffusion of gold atoms from the peg tip to the gold disk. This may lead to early peg deformation and recession, and ultimately failure of the head.

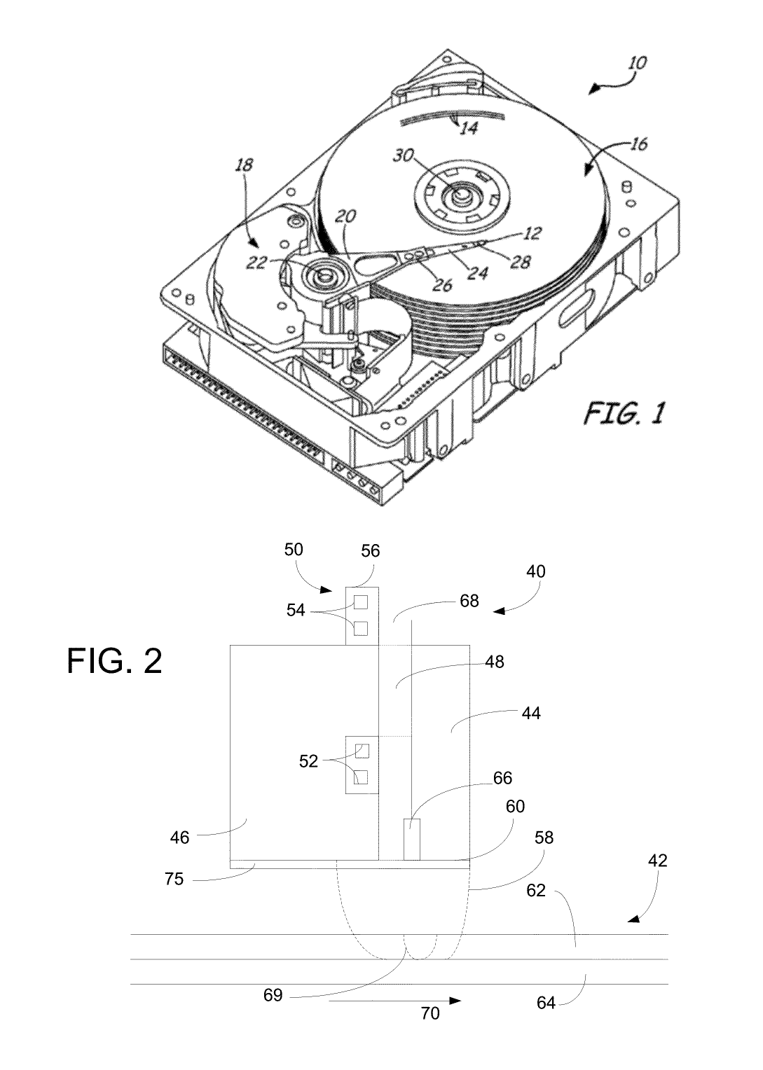

FIG. 1 is a perspective view of disc drive 10 including an actuation system for positioning slider 12 over track 14 of magnetic medium 16. The system depicted in FIGS. 1 and 2 can include disclosed structures and multilayer gas barrier layers. The particular configuration of disc drive 10 is shown for ease of description and is not intended to limit the scope of the present disclosure in any way. Disc drive 10 includes voice coil motor 18 arranged to rotate actuator arm 20 on a spindle around axis 22. Load beam 24 is connected to actuator arm 20 at head mounting block 26. Suspension 28 is connected to an end of load beam 24 and slider 12 is attached to suspension 28. Magnetic medium 16 rotates around an axis 30, so that the windage is encountered by slider 12 to keep it aloft a small distance above the surface of magnetic medium 16. Each track 14 of magnetic medium 16 is formatted with an array of data storage cells for storing data. Slider 12 carries a magnetic device or transducer (not shown in FIG. 1) for reading and/or writing data on tracks 14 of magnetic medium 16. The magnetic transducer utilizes additional electromagnetic energy to heat the surface of medium 16 to facilitate recording by a process termed heat assisted magnetic recording (HAMR).

A HAMR transducer includes a magnetic writer for generating a magnetic field to write to a magnetic medium (e.g. magnetic medium 16) and an optical device to heat a portion of the magnetic medium proximate to the write field. FIG. 2 is a cross sectional view of a portion of a magnetic device, for example a HAMR magnetic device 40 and a portion of associated magnetic storage medium 42. HAMR magnetic device 40 includes write pole 44 and return pole 46 coupled by pedestal 48. Coil 50 comprising conductors 52 and 54 encircles the pedestal and is supported by an insulator 56. As shown, magnetic storage medium 42 is a perpendicular magnetic medium comprising magnetically hard storage layer 62 and soft magnetic underlayer 64 but can be other forms of media, such as patterned media. A current in the coil induces a magnetic field in the pedestal and the poles. Magnetic flux 58 exits the recording head at air bearing surface (ABS) 60 and is used to change the magnetization of portions of magnetically hard layer 62 of storage medium 42 enclosed within region 58. Near field transducer (NFT) 66 is positioned adjacent the write pole 44 proximate air bearing surface 60. Positioned over the NFT 66 and optionally over other features in the HAMR magnetic device 40 is an overcoat 75. Near field transducer 66 is coupled to waveguide 68 that receives an electromagnetic wave from an energy source such as a laser. An electric field at the end of near field transducer 66 is used to heat a portion 69 of magnetically hard layer 62 to lower the coercivity so that the magnetic field from the write pole can affect the magnetization of the storage medium. As can be seen in FIG. 2, a portion of the near field transducer is positioned at the ABS 60 of the device.

Devices disclosed herein can also include other structures. Devices disclosed herein can be incorporated into larger devices. For example, sliders can include devices as disclosed herein. Exemplary sliders can include a slider body that has a leading edge, a trailing edge, and an air bearing surface. The write pole, read pole, optical near field transducer and contact pad (and optional heat sink) can then be located on (or in) the slider body. Such exemplary sliders can be attached to a suspension which can be incorporated into a disc drive for example. It should also be noted that disclosed devices can be utilized in systems other than disc drives such as that depicted in FIGS. 1 and 2.

In disclosed devices, the overcoat, positioned over at least the NFT, includes at least one material having a low thermal conductivity. Use of such an overcoat can minimize or even prevent thermal transformation from the magnetic media to the peg of the NFT. This may serve to reduce the temperature of the peg at the ABS and may therefore improve the thermal stability of the peg.

Disclosed overcoats can include more than one layer and may be characterized as a multilayer overcoat structure. In some embodiments, a disclosed overcoat includes at least one low thermal conductivity layer. A low thermal conductivity layer can include a material that has a thermal conductivity of not greater than 5 watts per meter Kelvin (W/mK), or in some embodiments not greater than 2 W/mK. The thermal conductivity of a material may depend on temperature. In some embodiments, the relevant thermal conductivity is the thermal conductivity at relatively high temperatures, for example at the media temperature during operation, for example not less than about 400° C.

In some embodiments, a low thermal conductivity layer can include materials such as fused silica (SiO₂), yttria stabilized zirconia (YSZ), cerium oxide (CeO₂), nickel oxide (NiO), thorium oxide (ThO₂), tantalum oxide (TaO), tantalum silicate (TaSiO), zirconium oxide (ZrO₂), or combinations thereof.

Thermal conductivity of materials can also be related to characteristics of the unit cell of materials. Based on the limiting conditions for the phonon mean free path and the effective atomic masses, the minimum thermal conductivity, Kₘᵢₙ is correlated to the mean atomic mass of the ions in the unit cell: density

$$ϖ = \frac{M}{m ρ {N}_{A}} \qquad ( Equation 2 )$$

Where κ_{b} is Boltzmann's constant, p is the density, E is Young's modulus, and ω̅ is an effective atomic volume:

$${K}_{min} = 0.87 {κ}_{b} {{ϖ}^{- 2 / 3} ( E / ρ )}^{1 / 2} \qquad ( Equation 1 )$$

Where M is the mean atomic mass of the ions in the unit cell, m is the number of ions in the unit cell, ρ is the density and N_{A} is Avagadro's number. From analyzing this equation, it can be seen that a large mean atomic mass and a low elastic modulus favor low thermal conductivity. One way to reduce thermal conductivity would be to introduce randomly distributed point defects into the structure at a sufficiently high density that they will cause in-elastic phonon scattering, thereby decreasing the phonon mean free path and decreasing the attainable thermal conductivity. For example, to further reduce the thermal conductivity of YSZ, rare-earth elements can be added to introduce defects.

Table 1 below shows calculated minimum thermal conductivities (Kₘᵢₙ) of various materials.

TABLE 1

| Compound | Kₘᵢₙ |
|---|---|
| BeO | 3.78 |
| SiC | 3.00 |
| Al₂O₃ | 2.89 |
| MgO | 2.56 |
| AlN | 2.45 |
| MgAl₂O₄ | 2.34 |
| TiO₂ | 2.07 |
| Mg₂SiO₄ | 2.00 |
| Mullite | 1.68 |
| ZrO₂ (YSZ) | 1.49 |
| NiO | 1.48 |
| LaMgAl₁₁O₁₉ | 1.48 |
| Gd₂Zr₂O₇ | 1.14 |
| Monazite | 1.13 |
| ThO₂ | 0.98 |

In some embodiments, a low thermal conductivity layer can also include doped materials such as zirconates (of which zirconium oxide is an example), e.g., Na₂ZrO₃ and Ca₂ZrO₄ for example. Illustrative dopants can include elements with relatively large atomic masses. Specific illustrative dopants can include one or more elements such as yttrium (Y), europium (Eu), thulium (Tm), lanthanum (La), ytterbium (Yb), gadolinium (Gd), or hafnium (Hf). Table 2 below shows the atomic mass and ionic radii of these various elements

TABLE 2

| Ion | Zr⁴⁺ | Hf⁴⁺ | Y²⁺ | Tm³⁺ | Eu³⁺ | Yb³⁺ | La³⁺ | Gd³⁺ |
|---|---|---|---|---|---|---|---|---|
| Atomic mass | 91.2 | 178.58 | 88.91 | 168.93 | 151.96 | 173.04 | 138.91 | 157.25 |
| (amu) | | | | | | | | |
| Ionic radius | 0.084 | 0.083 | 0.1019 | 0.0994 | 0.1066 | 0.0985 | 0.1160 | 0.1053 |
| (nm) | | | | | | | | |

In some embodiments, more than one dopant can be added to the zirconate (e.g., zirconium oxide (ZrO₂)). Some specific, illustrative doped zirconates can include, for example Gd₂Zr₂O₇, Sm₂Zr₂O₇, La₂Zr₂O₇, Nd₂Zr₂O₇, Zr₃Y₄O₁₂, 0.1WO₃-0.9 Nb₂O₅, WNb₁₂O₃₃, W₄Nb₂₆O₇₇, W₃Nb₁₄O₄₄, (3.5Eu-3.5Tm-7Y)SZ, (3.5Eu-3.5Yb-7Y)SZ, (Zr, Hf)₃Y₄O₁₂, Bi₃Ti₃O₁₂, Sr₂Nb₂O₇, La_{5/6}Yb_{1/6}Zr₂O₇., TaZrO, and NbZrO.

In some embodiments, a low thermal conductivity layer can include a tungsten niobate, a lanthanide orthophosphate, a lanthanum molybdate (e.g., such as W₃Nb₁₄O₄₄, La₂Mo₂O₉), or a monazite. In some embodiments, a low thermal conductivity layer can include LaPO₄, Dy₂SrAl₂O₇, SrZrO₃, 7YSZ, Yb₂Sn₂O₇, La(Mg_{1/4}Al_{1/2}Ta_{1/4})O₃, Gd₂Zr₂O₇, Ba₂ErAlO₅, BaNd₂Ti₃O₁₀, (Eu,Tm,Y)ZrO₂, W₃Nb₁₄O₄₄, (Zr,Hf)₃Y₄O₁₂, (Zr_{0.5}Hf_{0.5})_{0.87}Y_{0.13}O₂, Yb_{0.2}Ta_{0.2}Zr_{0.6}O₂, (La_{5/6}Yb_{1/6})Zr₂O₇, Sr₂Nb₂O₇, Bi₄Ti₃O₁₂, Gd₆Ca₄(SiO₄)₆O, La₂Mo₂O₉, 7YSZ+3.5EuO_{1.5}+3.5TmO_{1.5}, 7YSZ+3.5EuO_{0.15}+3.5YbO_{1.5}, 8YSZ, Zr₃Y₄O₁₂, W₃Nb₁₄O₄₄, WNb₁₂O₃₃, W₄Nb₂₆O₇₇, tri-doped YSZ (Zr,Hf)_{0.87}Y_{0.13}O_{1.93}, YPO₄, or combinations thereof.

In some embodiments, a low thermal conductivity layer can include a metal oxide having the formula ATaWO₆, where A can include potassium (K), rubidium (Rb), or cesium (Cs). In some embodiments, such metal oxides can have a b-pyrochlore structure. The thermal conductivities of such materials remains under 1.0 from 300 to 1000 K, with KTaWO₆ having the lowest thermal conductivity. In some embodiments, a low thermal conductivity layer can include a metal oxide having the formula X₂Z₂O₇, where X is lanthanum (La), praseodymium (Pr), neodymium (Nd), samarium (Sm), europium (Eu), gadolinium (Gd), yttrium (Y), erbium (Er), lutetium (Lu), or combinations thereof; and Z is titanium (Ti), molybdenum (Mo), tin (Sn), zirconium (Zr), lead (Pb), or combinations thereof. In some embodiments, a low thermal conductivity layer can include a material with both low thermal conductivity and a large thermal expansion coefficient. Illustrative specific materials can include, for example CeO₂, CeZrO₂, LaCe₂O₇, Sm₂Zr₂O₇, or films doped with MgO. In some embodiments, a low thermal conductivity layer can include TaSiO.

Optionally, low thermal conductivity layers can include materials that are disordered (e.g., WSe₂). Typically disordered materials will have relatively low thermal conductivities. Optionally, low thermal conductivity layers can include materials that are porous or have a substantial level of defects. Air or vacuum in the nanovoids of a porous film can also serve to reduce the thermal conductivity of a material.

In some embodiments, optical properties of the material of the low thermal conductivity layer can also be considered. The optical properties of the material may be relevant to the performance of the head. In some embodiments, the material can have a relatively high refractive index, for example not less than 1.5 or even not less than 2; a low extinction coefficient, for example not greater than 0.5 or even not greater than 0.1; or a combination thereof.

Low thermal conductivity layers can have various thicknesses. In some embodiments a low thermal conductivity layer in an overcoat structure can have a thickness of not greater than 10 nm, not greater than 5 nm, or even not greater than 1.5 nm. In some embodiments, a low thermal conductivity layer in an overcoat structure can have a thickness of not less than 0.1 nm, or even not less than 0.5 nm.

Disclosed overcoats can include low thermal conductivity layers as well as additional layers that may serve different purposes, provide different properties, or combinations thereof In some embodiments low thermal conductivity layers can be included with or utilized with a layer chosen to, configured to or designed to provide protection (physical, chemical, or both) to the underlying device. An example of such a protective coating can include diamond like carbon (DLC). The DLC layer can be included over the top of the low thermal conductivity layer, so that the DLC layer is exposed at the ABS of the device. In some embodiments low thermal conductivity layers can be included with or utilized with a layer chosen to, configured to, or designed to prevent corrosion of the low thermal conductivity layer (other layers or structures, or combinations thereof). In some embodiments low thermal conductivity layers can be included with or utilized with a layer chosen to, configured to, or designed to serve as a gas barrier layer to prevent diffusion of gases into the device. In some embodiments, low thermal conductivity layers can be included with or utilized with a layer chosen to, configured to, or designed to improve adhesion of the overlying DLC layer and the underling low thermal conductivity layer. In some embodiments, low thermal conductivity layers can be included with or utilized with a layer chosen to, configured to, or designed to improve adhesion of the underlying structure (e.g., the peg and/or other portions of the magnetic head) to the low thermal conductivity layer. It should also be noted that a single layer can be chosen to, configured to, or designed to provide more than one property.

Illustrative embodiments of overcoat structures can include a low thermal conductivity layer in contact with at least the peg of the NFT and then a protective layer (e.g., a DLC layer) over the low thermal conductivity layer so that the protective layer is exposed at the ABS of the device. Illustrative embodiments of overcoat structures can include a low thermal conductivity layer in contact with at least the peg of the NFT, an adhesion layer adjacent the low thermal conductivity layer and then a protective layer (e.g., a DLC layer) over the low thermal conductivity layer so that the protective layer is exposed at the ABS of the device; in such embodiments, the adhesion layer is positioned between the low thermal conductivity layer and the protective layer and the adhesion layer can be chosen to, configured to or designed to increase adhesion of the protective layer to the low thermal conductivity layer. Illustrative embodiments of overcoat structures can include a low thermal conductivity layer in contact with at least the peg of the NFT, a corrosion resistance layer adjacent the low thermal conductivity layer and then a protective layer (e.g., a DLC layer) over the low thermal conductivity layer so that the protective layer is exposed at the ABS of the device; in such embodiments, the corrosion resistance layer is positioned between the low thermal conductivity layer and the protective layer. Illustrative embodiments of overcoat structures can include an adhesion layer in contact with at least the peg of the NFT, a low thermal conductivity layer adjacent the adhesion layer and then a protective layer (e.g., a DLC layer) over the adhesion layer so that the protective layer is exposed at the ABS of the device; in such embodiments, the adhesion layer is positioned between the low thermal conductivity layer and at least the peg of the NFT and the low thermal conductivity layer is positioned between the protective layer and the adhesion layer. Illustrative embodiments of overcoat structures can include a low thermal conductivity layer in contact with at least the peg of the NFT, a gas barrier layer adjacent the low thermal conductivity layer and then a protective layer (e.g., a DLC layer) over the low thermal conductivity layer so that the protective layer is exposed at the ABS of the device; in such embodiments, the gas barrier layer is positioned between the low thermal conductivity layer and the protective layer. Illustrative embodiments of overcoat structures can include a first adhesion layer in contact with at least the peg of the NFT, a low thermal conductivity layer in contact with the first adhesion layer, a second adhesion layer adjacent the low thermal conductivity layer and then a protective layer (e.g., a DLC layer) over the low thermal conductivity layer so that the protective layer is exposed at the ABS of the device; in such embodiments, the first adhesion layer is positioned between the low thermal conductivity layer and at least the NFT of the peg, the second adhesion layer is positioned between the low thermal conductivity layer and the protective layer. It should also be noted that any combinations of one or more of any of the disclosed optional layers can be utilized with low thermal conductivity layers.

In some embodiments where an adhesion layer is optionally utilized between at least the peg of the NFT and the low thermal conductivity layer, such an adhesion layer may include one or more metals. In some embodiments, this adhesion layer or metal layer is relatively thin so that the optical absorption by the layer is not excessively high. In some embodiments, such an adhesion layer can have a thickness of not greater than 10 nm, or even not greater than 5 nm; and not less than 0.1 nm or even not less than 0.5 nm. In some embodiments, such an adhesion layer can include one or more of iridium (Ir), rhodium (Rh), ruthenium (Ru), rhenium (Re), chromium (Cr), tantalum (Ta), titanium (Ti), nickel (Ni), platinum (Pt), lead (Pb), zirconium (Zr), niobium (Nb), or combinations thereof. In some embodiments, an adhesion layer between the low thermal conductivity layer and the protective layer (e.g., DLC) can include yttrium oxide (YO), aluminum oxide (AlO), tantalum oxide (TaO), or combinations thereof.

In some embodiments where a corrosion resistance layer is optionally utilized between the low thermal conductivity layer and the protective layer, such a corrosion resistance layer can include tantalum oxide (TaO) for example. In some embodiments, such a corrosion resistance layer can have a thickness of not greater than 10 nm, or even not greater than 5 nm; and not less than 0.1 nm or even not less than 0.5 nm.

In some embodiments more than one low thermal conductivity layer can be utilized in an overcoat structure. More than one layer of low thermal conductivity material may be useful and/or beneficial because interfaces of materials introduce defects into the material. These defects may increase phonon scattering, thereby obtaining lower thermal conductivity. The lows thermal conductivity may be especially low perpendicular to the plane of the films, which may be the most important axis given back heating from the media. In some embodiments, the same phenomenon may be able to be captured by having multiple layers with mismatched phonons.

In such embodiments each layer of low thermal conductivity material and the layers between them, referred to herein as interlayers can have thicknesses of not greater than 10 nm, not greater than 3 nm, not greater than 1 nm, or not greater than 0.5 nm; and may have thicknesses not less than 0.0.1 nm, or not less than 0.1 nm. In some embodiments, layers (both low thermal conductivity layers and interlayers) which are relatively thin (e.g., not greater than 1 nm, or not greater than 0.5 nm) may be advantageous because such layers may intermix with each other. In some embodiments two layers of low thermal conductivity material separated by an interlayer can be utilized. In some embodiments, interlayers can provide gas barrier properties. In some embodiments, an interlayer or interlayers can be made of oxides, nitrides, silicides, oxynitrides, or any combination thereof

Low thermal conductivity layers disclosed herein can be made using various deposition methods. In some embodiments, the materials could be deposited from composite targets, co-deposited from two targets, or a combination thereof. In some embodiments, the materials could be deposited using ion implantation. In some embodiments, the materials could be deposited by depositing multiple alternate layers. In some embodiments, during the deposition, a negative substrate bias could be applied to cause and/or favor intermixing of the layers to form the desired material or layers. In such embodiments, the substrate bias could be DC, pulsed DC, AC, RF, or any combinations thereof. In such embodiments, the voltage of the substrate bias could be not greater than 100 kV, or not greater than 60 kv; or not less than −100 V, or not less than −10 V.

Generally, the low thermal conductivity layers could be deposited using any physical vapor deposition or chemical vapor deposition process, including processes such as magnetron sputtering, ion beam assisted deposition (IBD), laser ablation, filtered cathodic arc, evaporation, ionized magnetron sputtering, chemical vapor deposition, plasma enhanced chemical vapor deposition (PECVD), rf PECVD, microwave PECVD, atomic layer deposition (ALD), or plasma assisted atomic layer deposition.

In some embodiments, a low thermal conductivity layer can be formed by depositing a metal film or films and then utilizing an oxidation process. Such an oxidation process could add oxygen atoms into the metallic layer. This may cause expansion of the metal lattice, and therefore, a reduction in the defect density (i.e. vacancy, grain boundary, dislocation, and pin holes) in the HOC. This may increase corrosion resistance of the layer being formed. The oxidation process could be an air oxidation process, air isothermal oxidation process, plasma oxidation process, remote plasma oxidation process, ozone oxidation process or combinations thereof.

In some embodiments, a low thermal conductivity layer can be formed by deposition of a metal rich amorphous films in an argon (Ar) atmosphere followed by an oxidation process to form a fully oxidized amorphous film. The oxidation process could be an air oxidation process, air isothermal oxidation process, plasma oxidation process, remote plasma oxidation process, ozone oxidation process or combinations thereof.

### Examples

A specific, illustrative example of an overcoat structure can include a multilayer structure of YO (in contact with at least the peg of the NFT), SiO (between the YO and the DLC) and DLC as the protective layer.

A specific, illustrative example of an overcoat structure can include a multilayer structure of YSZ (in contact with at least the peg of the NFT), SiO (between the YSZ and the DLC) and DLC as the protective layer.

A specific, illustrative example of an overcoat structure can include a multilayer structure of YSZ (in contact with at least the peg of the NFT), TaO (between the YSZ and the DLC) and DLC as the protective layer.

A specific, illustrative example of an overcoat structure can include a multilayer structure of 1 nm AlO (in contact with at least the peg of the NFT) as an adhesion layer, 1 nm SiO/0.5 nm TaO/0.5 nm SiO/1 nm TaO and then a 1.5 nm DLC as the protective layer.

A specific, illustrative example of an overcoat structure can include a multilayer structure of 1 nm AlO (in contact with at least the peg of the NFT) as an adhesion layer, 1 nm SiO/1 nm TaSiO/1 nm SiO and then a 1.5 nm DLC as the protective layer.

A specific, illustrative example of an overcoat structure can include a multilayer structure of 1 nm AlO (in contact with at least the peg of the NFT) as an adhesion layer, 1 nm TaSiO/1 nm SiO/1 nm TaO (chosen to prevent corrosion) and then a 1.5 nm DLC as the protective layer.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, “top” and “bottom” (or other terms like “upper” and “lower”) are utilized strictly for relative descriptions and do not imply any overall orientation of the article in which the described element is located.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. For example, a conductive trace that “comprises” silver may be a conductive trace that “consists of” silver or that “consists essentially of” silver.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

Use of “first,” “second,” etc. in the description above and the claims that follow is not intended to necessarily indicate that the enumerated number of objects are present. For example, a “second” substrate is merely intended to differentiate from another infusion device (such as a “first” substrate). Use of “first,” “second,” etc. in the description above and the claims that follow is also not necessarily intended to indicate that one comes earlier in time than the other.

As used herein, “about” or “approximately” shall generally mean within 20 percent, within 10 percent, or within 5 percent of a given value or range. “about” can also in some embodiments imply a range dictated by a means of measuring the value at issue. Other than in the examples, or where otherwise indicated, all numbers are to be understood as being modified in all instances by the term “about”.

Thus, embodiments of devices including an overcoat that includes a low thermal conductivity layer are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A device having an air bearing surface (ABS), the device comprising:
a write pole;
a near field transducer (NFT) comprising a peg and a disc, wherein the peg is at the ABS of the device;
an overcoat, the overcoat comprising:
a low thermal conductivity layer, the low thermal conductivity layer comprising a material that has a thermal conductivity of not greater than 5 W/mK.

2. The device according to claim 1, wherein the low thermal conductivity layer comprises a material that has a thermal conductivity of not greater than 2 W/mK.

3. The device according to claim 1, wherein the low thermal conductivity layer comprises fused silica (SiO₂), yttria stabilized zirconia (YSZ), cerium oxide (CeO₂), nickel oxide (NiO), thorium oxide (ThO₂), tantalum oxide (TaO), tantalum silicate (TaSiO), zirconium oxide (ZrO₂), or combinations thereof.

4. The device according to claim 1, wherein the low thermal conductivity layer comprises tantalum silicate (TaSiO).

5. The device according to claim 1, wherein the low thermal conductivity layer comprises SiO₂, YSZ, CeO₂, NiO, ThO₂, TaSiO, ZrO₂, MgAl₂O₄, Mullite, Gd₂Zr₂O₇, LaMgAl₁₁O₁₉, Monazite, Sm₂Zr₂O₇, La₂Zr₂O₇, Nd₂Zr₂O₇, Zr₃Y₄O₁₂, 0.1WO₃-0.9 Nb₂O₅, WNb₁₂O₃₃, W₄Nb₂₆O₇₇, W₃Nb₁₄O₄₄, (3.5Eu-3.5Tm-7Y)SZ, (3.5Eu-3.5Yb-7Y)SZ, (Zr, Hf)₃Y₄O₁₂, Bi₃Ti₃O₁₂, Sr₂Nb₂O₇, La_{5/6}Yb_{1/6}Zr₂O₇., TaZrO, NbZrO, or combinations thereof.

6. The device according to claim 1, wherein the low thermal conductivity layer comprises LaPO₄, Dy₂SrAl₂O₇, SrZrO₃, 7YSZ, Yb₂Sn₂O₇, La(Mg_{1/4}Al_{1/2}Ta_{1/4})O₃, Gd₂Zr₂O₇, Ba₂ErAlO₅, BaNd₂Ti₃O₁₀, (Eu,Tm,Y)ZrO₂, W₃Nb₁₄O₄₄, (Zr,Hf)₃Y₄O₁₂, (Zr_{0.5}Hf_{0.5})_{0.87}Y_{0.13}O₂, Yb_{0.2}Ta_{0.2}Zr_{0.6}O₂, (La_{5/6}Yb_{1/6})Zr₂O₇, Sr₂Nb₂O₇, Bi₄Ti₃O₁₂, Gd₆Ca₄(SiO₄)₆O, La₂Mo₂O₉, 7YSZ+3.5EuO_{1.5}+3.5TmO_{1.5}, 7YSZ+3.5EuO_{0.15}+3.5YbO_{1.5}, 8YSZ, Zr₃Y₄O₁₂, W₃Nb₁₄O₄₄, WNb₁₂O₃₃, W₄Nb₂₆O₇₇, tri-doped YSZ (Zr,Hf)_{0.87}Y_{0.13}O_{1.93}, YPO₄, WSe₂, or combinations thereof.

7. The device according to claim 1, wherein the low thermal conductivity layer has a refractive index of not less than 1.5, an extinction coefficient of not greater than 0.5, or both.

8. The device according to claim 1 further comprising a diamond like carbon (DLC) layer disposed on at least a portion of the low thermal conductivity layer.

9. The device according to claim 1 further comprising a corrosion resistant layer, a gas barrier layer, an adhesion layer, or any combination thereof.

10. The device according to claim 1, wherein the low thermal conductivity layer is in contact with at least the peg of the NFT.

11. The device according to claim 10 further comprising a corrosion resistant layer, a gas barrier layer, an adhesion layer, or any combination thereof in contact with the low thermal conductivity layer on the side of the low thermal conductivity layer opposite the peg, and an overcoat layer in contact with the gas barrier layer, an adhesion layer, or any combination thereof.

12. The device according to claim 1, wherein the low thermal conductivity layer comprises a multilayer structure comprising at least two layers of low thermal conductivity material.

13. A device having an air bearing surface (ABS), the device comprising:
a write pole;
a near field transducer (NFT) comprising a peg and a disc, wherein the peg is at the ABS of the device;
an overcoat, the overcoat comprising:
a low thermal conductivity layer in contact with at least the peg of the NFT, the low thermal conductivity layer comprising a material that has a thermal conductivity of not greater than 5 W/mK.

14. The device according to claim 13, wherein the low thermal conductivity layer comprises:
fused silica (SiO₂), yttria stabilized zirconia (YSZ), cerium oxide (CeO₂), nickel oxide (NiO), thorium oxide (ThO₂), tantalum oxide (TaO), tantalum silicate (TaSiO), zirconium oxide (ZrO₂), or combinations thereof;
YSZ, CeO₂, NiO, ThO₂, TaSiO, MgAl₂O₄, Mullite, Gd₂Zr₂O₇, LaMgAl₁₁O₁₉, Monazite, Sm₂Zr₂O₇, La₂Zr₂O₇, Nd₂Zr₂O₇, Zr₃Y₄O₁₂, 0.1WO₃-0.9 Nb₂O₅, WNb₁₂O₃₃, W₄Nb₂₆O₇₇, W₃Nb₁₄O₄₄, (3.5Eu-3.5Tm-7Y)SZ, (3.5Eu-3.5Yb-7Y)SZ, (Zr, Hf)₃Y₄O₁₂, Bi₃Ti₃O₁₂, Sr₂Nb₂O₇, La_{5/6}Yb_{1/6}Zr₂O₇., TaZrO, NbZrO, or combinations thereof;
LaPO₄, Dy₂SrAl₂O₇, SrZrO₃, 7YSZ, Yb₂Sn₂O₇, La(Mg_{1/4}Al_{1/2}Ta_{1/4})O₃, Gd₂Zr₂O₇, Ba₂ErAlO₅, BaNd₂Ti₃O₁₀, (Eu,Tm,Y)ZrO₂, W₃Nb₁₄O₄₄, (Zr,Hf)₃Y₄O₁₂, (Zr_{0.5}Hf_{0.5})_{0.87}Y_{0.13}O₂, Yb_{0.2}Ta_{0.2}Zr_{0.6}O₂, (La_{5/6}Yb_{1/6})Zr₂O₇, Sr₂Nb₂O₇, Bi₄Ti₃O₁₂, Gd₆Ca₄(SiO₄)₆O, La₂Mo₂O₉, 7YSZ+3.5EuO_{1.5}+3.5TmO_{1.5}, 7YSZ+3.5EuO_{0.15}+3.5YbO_{1.5}, 8YSZ, Zr₃Y₄O₁₂, W₃Nb₁₄O₄₄, WNb₁₂O₃₃, W₄Nb₂₆O₇₇, tri-doped YSZ (Zr,Hf)_{0.87}Y_{0.13}O_{1.93}, YPO₄, WSe₂, or combinations thereof; or
combinations thereof.

15. The device according to claim 13 further comprising a corrosion resistant layer, a gas barrier layer, an adhesion layer, or any combination thereof in contact with the low thermal conductivity layer on the side of the low thermal conductivity layer opposite the peg, and an overcoat layer in contact with the gas barrier layer, an adhesion layer, or any combination thereof.

16. The device according to claim 15, wherein the protective layer comprises diamond like carbon (DLC).

17. The device according to claim 13, wherein the low thermal conductivity layer comprises a multilayer structure comprising at least two layers of low thermal conductivity material.

18. A device having an air bearing surface (ABS), the device comprising:
a write pole;
a near field transducer (NFT) comprising a peg and a disc, wherein the peg is at the ABS of the device;
an overcoat, the overcoat comprising:
a low thermal conductivity layer in contact with at least the peg of the NFT, the low thermal conductivity layer comprising a material that has a thermal conductivity of not greater than 5 W/mK; and
a protective layer.

19. The device according to claim 18 further comprising a corrosion resistant layer, a gas barrier layer, an adhesion layer, or any combination thereof positioned between the low thermal conductivity layer and the protective layer.

20. The device according to claim 18, wherein the low thermal conductivity layer comprises:
fused silica (SiO₂), yttria stabilized zirconia (YSZ), cerium oxide (CeO₂), nickel oxide (NiO), thorium oxide (ThO₂), tantalum oxide (TaO), tantalum silicate (TaSiO), zirconium oxide (ZrO₂), or combinations thereof;
YSZ, CeO₂, NiO, ThO₂, TaSiO, MgAl₂O₄, Mullite, Gd₂Zr₂O₇, LaMgAl₁₁O₁₉, Monazite, Sm₂Zr₂O₇, La₂Zr₂O₇, Nd₂Zr₂O₇, Zr₃Y₄O₁₂, 0.1WO₃-0.9 Nb₂O₅, WNb₁₂O₃₃, W₄Nb₂₆O₇₇, W₃Nb₁₄O₄₄, (3.5Eu-3.5Tm-7Y)SZ, (3.5Eu-3.5Yb-7Y)SZ, (Zr, Hf)₃Y₄O₁₂, Bi₃Ti₃O₁₂, Sr₂Nb₂O₇, La_{5/6}Yb_{1/6}Zr₂O₇., TaZrO, NbZrO, or combinations thereof;
LaPO₄, Dy₂SrAl₂O₇, SrZrO₃, 7YSZ, Yb₂Sn₂O₇, La(Mg_{1/4}Al_{1/2}Ta_{1/4})O₃, Gd₂Zr₂O₇, Ba₂ErAlO₅, BaNd₂Ti₃O₁₀, (Eu,Tm,Y)ZrO₂, W₃Nb₁₄O₄₄, (Zr,Hf)₃Y₄O₁₂, (Zr_{0.5}Hf_{0.5})_{0.87}Y_{0.13}O₂, Yb_{0.2}Ta_{0.2}Zr_{0.6}O₂, (La_{5/6}Yb_{1/6})Zr₂O₇, Sr₂Nb₂O₇, Bi₄Ti₃O₁₂, Gd₆Ca₄(SiO₄)₆O, La₂Mo₂O₉, 7YSZ+3.5EuO_{1.5}+3.5TmO_{1.5}, 7YSZ+3.5EuO_{0.15}+3.5YbO_{1.5}, 8YSZ, Zr₃Y₄O₁₂, W₃Nb₁₄O₄₄, WNb₁₂O₃₃, W₄Nb₂₆O₇₇, tri-doped YSZ (Zr,Hf)_{0.87}Y_{0.13}O_{1.93}, YPO₄, WSe₂, or combinations thereof or combinations thereof.
